(19) United States
(12) Patent Application Publication
(10) Pub. No.: US 2025/0148401 A1
(43) Pub. Date: May 8, 2025

(54) METHOD AND SYSTEM OF COORDINATING CLEARANCE OF A WORK AREA

(71) Applicant: Deere & Company, Moline, IL (US)

(72) Inventors: Jeremy B. Shuler, Polk City, IA (US); Francois Stander, Dubuque, IA (US)

(21) Appl. No.: 18/502,751

(22) Filed: Nov. 6, 2023

(51) Int. Cl. G06Q 10/08; G05D 1/02

(52) U.S. Cl. CPC G06Q 10/08

(57) ABSTRACT

A method of coordinating clearance of a work area may comprise, via one or more work machines, comminuting material from a work area and delivering the comminuted material into one or more stockpiles; automatically monitoring, via one or more perception sensors, and for at least a first stockpile of the one or more stockpiles, one or more multidimensional characteristics thereof; ascertaining (e.g., detecting and/or predicting) boundary conditions associated with the at least first stockpile, based at least in part on the monitored one or more multidimensional characteristics thereof; and upon initiating or reestablishing communication between at least a first work machine of the one or more work machines and at least a first stockpile clearing vehicle of one or more stockpile clearing vehicles associated with the work area, selectively generating output signals corresponding to the one or more multidimensional characteristics and/or the boundary condition of the at least first stockpile.

### FIELD OF THE DISCLOSURE

The present disclosure relates generally to coordinating clearance of a work area, and more particularly to monitoring multidimensional characteristics of stockpiles of comminuted material, detecting boundary conditions associated with the stockpiles, and selectively generating output signals associated with the multidimensional characteristics and/or boundary conditions.

### BACKGROUND

Material comminution systems may include several mobile or stationary work machines. One such work machine may be a material crusher or crusher plant conventionally known for comminuting (crushing) material, for example stone material including but not limited to natural stone, concrete, brick, demolition rubble, recycling material, or the like. The material comminution system may include a single material crusher, or alternatively a plurality of material crushers sequentially positioned. Once the material has been comminuted or crushed, the comminuted material may be passed to a discharge conveyor apparatus, such as a screener machine or a screening plant to name a few examples. The discharge conveyor apparatus may be operable to separate the comminuted material based on one or more material characteristics, such as material size to name one example. The discharge conveyor apparatus may sort the comminuted material onto different conveyors based on the material characteristics of the comminuted material. Each conveyor may then convey the comminuted material from the discharge conveyor apparatus onto a stockpile. Thus, the discharge conveyor apparatus may create several stockpiles, each consisting of a different grade of comminuted materials.

One or more stockpile clearing vehicles may be associated with the work area and operable to collect and transport the comminuted material from the stockpiles to a remote location, such as a long-term storage area to name an example. The stockpile clearing machines may include excavators, skid-steer loaders, front end loaders, tractor loaders, wheel loaders, and compact loaders to name a few examples. The stockpile clearing machines may have buckets or other implements for scooping and holding the comminuted material.

The operator of the stockpile clearing vehicle may, at times, be unable to see the stockpiles created by the discharge conveyor apparatus. For example, the stockpile clearing vehicles may be performing other tasks around the work area. In another example, the stockpile clearing vehicles may be operating in areas where the operator is unable to see the stockpiles, in some cases due to distance and elevation changes. As the discharge conveyor apparatus continues to convey comminuted material onto the stockpiles, the stockpiles grow. One concern is that the stockpile will grow and reach the conveyor of the discharge conveyor apparatus from which the comminuted material is being conveyed. If the stockpile clearing vehicle is operating away from the stockpiles, the operator may not be aware of the size of the stockpile and/or that the stockpile needs to be cleared.

Accordingly, a need exists for improvements in coordinating clearance of a work area that include material comminution systems.

### SUMMARY OF THE DISCLOSURE

One aspect in accordance with the optional embodiments disclosed herein is a method of coordinating clearance of a work area. The method may include, via one or more work machines, comminuting material from a work area and delivering the comminuted material into one or more stockpiles. The method may further include monitoring, via one or more perception sensors, and for at least a first stockpile of the one or more stockpiles, one or more multidimensional characteristics thereof. The method may further include detecting and/or predicting a boundary condition associated with the at least first stockpile, based at least in part on the monitored one or more multidimensional characteristics thereof. The method may further include, upon initiating or reestablishing communication between at least a first work machine of the one or more work machines and at least a first stockpile clearing vehicle of one or more stockpile clearing vehicles associated with the work area, selectively generating output signals corresponding to the one or more multidimensional characteristics and/or the boundary condition of the at least first stockpile.

In another aspect in accordance with the optional embodiments disclosed herein, the boundary condition may be detected and/or predicted via a controller associated with the at least first work machine.

In another aspect in accordance with the optional embodiments disclosed herein, the boundary condition may be detected and/or predicted via a controller associated with the at least first stockpile clearing vehicle.

In another aspect in accordance with the optional embodiments disclosed herein, communication may be initiated or reestablished between the at least first work machine and the at least first stockpile clearing vehicle in the work area based at least in part on proximity of the at least first work machine relative to the at least first stockpile clearing vehicle.

In another aspect in accordance with the optional embodiments disclosed herein, communication between the at least first work machine and the at least first stockpile clearing vehicle may be done via a preexisting work area communications network.

In another aspect in accordance with the optional embodiments disclosed herein, further comprising detecting a growth rate of the at least first stockpile in the work area via at least a controller associated with the at least first work machine.

In another aspect in accordance with the optional embodiments disclosed herein, the step of selectively generating output signals includes selectively generating an output signal corresponding to an alert when the one or more multidimensional characteristics and/or the boundary condition of the at least first stockpile reaches a predetermined threshold.

In another aspect in accordance with the optional embodiments disclosed herein, further comprising performing a loading operation via the at least one stockpile clearing vehicle wherein the comminuted material is removed from the at least first stockpile in the work area.

In another aspect in accordance with the optional embodiments disclosed herein, further comprising adjusting the predicted boundary condition associated with the at least first stockpile in the work area in response to the loading operation.

In another aspect in accordance with the optional embodiments disclosed herein, further comprising selectively generating either a positive response signal or a negative response signal via the at least first stockpile clearing vehicle, wherein the positive response signal indicates the at least first stockpile clearing vehicle intends to perform a loading operation, and the negative response signal indicates that the at least first stockpile clearing vehicle does not intend to perform the loading operation.

In another aspect in accordance with the optional embodiments disclosed herein, further comprising, upon receiving the negative response signal from the at least first stockpile clearing vehicle in the work area, generating additional output signals corresponding to the boundary condition of the at least first stockpile in the work area.

In another aspect in accordance with the optional embodiments disclosed herein, further comprising, upon receiving the positive response signal from the at least first stockpile clearing vehicle in the work area, stopping the generation of output signals corresponding to the boundary condition of the at least first stockpile in the work area.

In another aspect in accordance with the optional embodiments disclosed herein, the boundary condition corresponds at least in part to a volume of the at least one stockpile in the work area.

Another aspect in accordance with the optional embodiments disclosed herein is a system of coordinating clearance of a work area. The system may comprise one or more work machines, one or more perception sensors, and a controller. The one or more work machines may be configured to comminute material from a work area and deliver the comminuted material into one or more stockpiles. The one or more perception sensors may be configured to monitor, for at least a first stockpile, one or more multidimensional characteristics thereof. The controller may be configured to detect and/or predict a boundary condition associated with the at least first stockpile, based at least in part on the monitored one or more multidimensional characteristics thereof. The controller may be configured to, upon initiating or reestablishing communication between at least a first work machine of the one or more work machines and at least a first stockpile clearing vehicle of one or more stockpile clearing vehicles associated with the work area, selectively generate output signals corresponding to the one or more multidimensional characteristics and/or the boundary condition of the at least one stockpile.

In another aspect in accordance with the optional embodiments disclosed herein, the controller may be associated with the at least first work machine.

In another aspect in accordance with the optional embodiments disclosed herein, communication may be initiated or reestablished between the at least first work machine and the at least first stockpile clearing vehicle based at least in part on proximity of the at least first work machine relative to the at least first stockpile vehicle.

In another aspect in accordance with the optional embodiments disclosed herein, further comprising a work area communications network configured to enable communication between the at least first work machine and the at least first stockpile clearing vehicle.

In another aspect in accordance with the optional embodiments disclosed herein, the controller may be configured to detect a growth rate of the at least first stockpile in the work area.

In another aspect in accordance with the optional embodiments disclosed herein, the controller may be configured to generate an output signal corresponding to an alert when the one or more multidimensional characteristics and/or the boundary condition of the at least first stockpile reaches a predetermined threshold.

In another aspect in accordance with the optional embodiments disclosed herein, the one or more stockpile clearing vehicles may be configured to perform a loading operation wherein the comminuted material is removed from the at least first stockpile in the work area.

Numerous objects, features and advantages of the present invention will be readily apparent to those skilled in the art upon a review of the following description in conjunction with the accompanying drawings.

### BRIEF DESCRIPTION OF THE DRAWINGS

FIG. 1 is graphical diagram representing a system of coordinating clearance of a work area of the present disclosure.

FIG. 2 is a block diagram representing a controller of the system of FIG. 1 in accordance with the present disclosure.

FIG. 3 is a block diagram representing a method of coordinating clearance of a work area of the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected,” “attached,” “joined,” “mounted,” “fastened,” and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

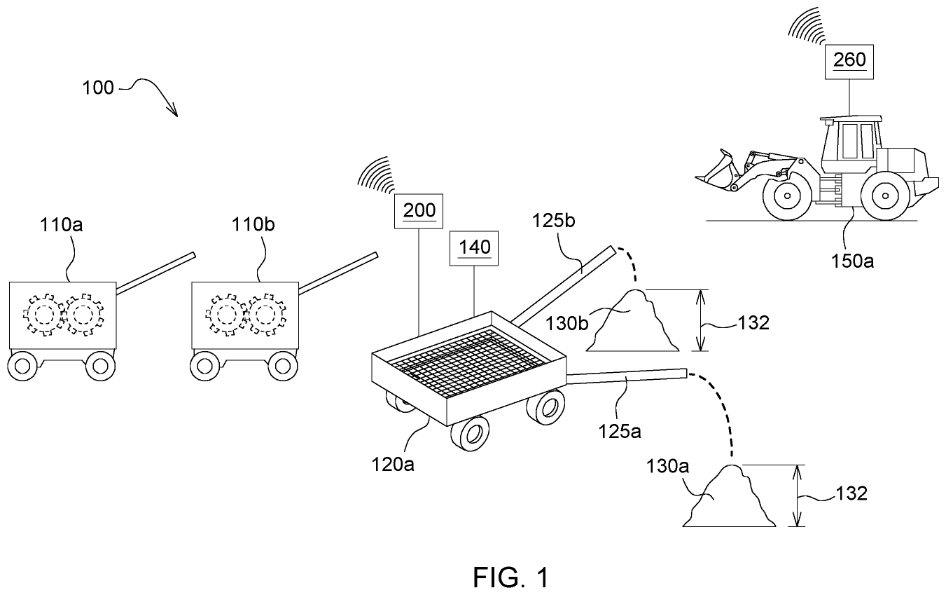

Referring now to the figures, and specifically FIG. 1, a system of coordinating clearance of a work area is shown and generally designated by the number 100.

The system 100 includes one or more work machines 110, 120. In typical embodiments, the one or more work machines include one or more material crushers or crusher plants 110a, 110b, . . . , 110n. Each of the one or more material crushers 110a, 110b, . . . , 110n may be generally referred to herein as a material crusher 110. Each of the one or more material crushers 110a, 110b, . . . , 110n may be configured to comminute (crush) material, for example stone material including but not limited to natural stone, concrete, brick, demolition rubble, recycling material, or the like. The system 100 may include a single material crusher 110a, or alternatively a plurality of material crushers 110a, 110b, . . . , 110n sequentially positioned. Thus, the material may be comminuted and passed amongst the plurality of material crushers 110a, 110b, . . . , 110n as desired.

In an exemplary embodiment (not specifically shown), at least one primary material crusher may include at least one jaw, impact, or gyratory crusher arranged and configured to perform initial crushing operations to reduce the size of blasted rock loaded therein by, for example, an excavator. At least one secondary material crusher may include a cone crusher further arranged and configured to perform supplemental crushing operations to produce a desired size and shape of the comminuted material.

The work machines 110, 120 of the system 100 may include one or more material screening machines 120a, 120b, . . . , 120n. The one or more material screening machines 120a, 120b, . . . , 120n may be configured to receive comminuted material from the plurality of material crushers 110a, 110b, . . . , 110n. The one or more material screening machines 120a, 120b, . . . 120n may include a discharge conveyor apparatus. For example, each of a plurality of material screening machines 120 may include a respective conveyor 125, or a respective material screening machine 120a may include a plurality of conveyors 125a, 125b, . . . , 125n. Each of the plurality of conveyors 125a, 125b, . . . , 125n may be operable to convey comminuted material from the respective material screening machines 120. Each material screening machines 120 may be configured to screen, sort, or otherwise separate the comminuted material amongst the plurality of conveyors 125a, 125b, . . . , 125n based on characteristics of the comminuted material, such as the size or grade of the comminuted material for example.

In certain optional embodiments, at least one work machine 110, 120 may be a material crusher 110 having combined structure and functionality with respect to a material screening machine 120.

The one or more material screening machines 120a, 120b, . . . , 120n may be configured to deliver or otherwise arrange comminuted material from the work area into one or more stockpiles 130a, 130b, . . . , 130n. Alternatively, in certain embodiments, material screening functions may be omitted or substantially modified such that comminuted material is delivered directly from one or more material crushers into respective stockpiles 130a, 130b, . . . , 130n. Each of the one or more stockpiles 130a, 130b, . . . , 130n may be generally referred to herein as a stockpile 130. Each material screening machine 120, and more specifically each of the plurality of conveyors 125a, 125b, . . . , 125n regardless of the type or number of associated work machines 110, 120, may convey comminuted material into a respective one of the one or more stockpiles 130a, 130b, 130n.

The system 100 may include one or more perception sensors 140a, 140b, . . . , 140n. Each of the one or more perception sensors 140a, 140b, . . . , 140n may be generally referred to herein as a perception sensor 140. Each of the one or more perception sensors 140a, 140b, . . . , 140n may be configured to monitor one or more multidimensional characteristics 160 for at least a first stockpile 130a of the one or more stockpiles 130a, 130b, . . . , 130n. In certain optional embodiments, the one or more perception sensors 140a, 140b, . . . , 140n may monitor one or more multidimensional characteristics 160 for multiple stockpiles 130a, 130b, . . . , 130n. The one or more perception sensors 140a, 140b, . . . , 140n may in an embodiment be associated with the one or more work machines 110, 120. Thus, the one or more perception sensors 140a, 140b, . . . , 140n may for example be associated with a discharge conveyor apparatus of the one or more material screening machines 120a, 120b, . . . , 120n and/or the plurality of material crushers 110a, 110b, . . . , 110n. The one or more perception sensors 140a, 140b, . . . , 140n may be mounted to, integrated with, or otherwise associated with a work machine 110, 120.

The system 100 may include, or otherwise be operable in association with, at least a respective user interface for each of one or more stockpile clearing vehicles 150a, 150b, . . . , 150n. Each of the one or more stockpile clearing vehicles 150a, 150b, . . . , 150n may be generally referred to herein as a stockpile clearing vehicle 150. The one or more stockpile clearing vehicles may include excavators, skid-steer loaders, front end loaders, tractor loaders, wheel loaders, and compact loaders to name a few examples. Each of the one or more stockpile clearing vehicles 150a, 150b, . . . , 150n may include a work implement, such as a bucket to name an example, for acquiring material from a stockpile and either transporting the material itself or loading the material into a separate transport vehicle such as a dump truck or a container that can be selectively transported with the material therein.

The one or more stockpile clearing vehicles 150a, 150b, . . . , 150n may be configured to perform a loading operation wherein the comminuted material is removed from at least a first stockpile 130a in the work area. In certain optional embodiments of the loading operation, the one or more stockpile clearing vehicles 150a, 150b, . . . , 150n may scoop and hold all or a portion of the comminuted material of the stockpile 130a and transport the comminuted material to a remote location, such as a long-term storage site to name an example. The one or more stockpile clearing vehicles 150a, 150b, . . . , 150n may move throughout the work area and beyond, and their proximity to the one or more work machines 110, 120 may change.

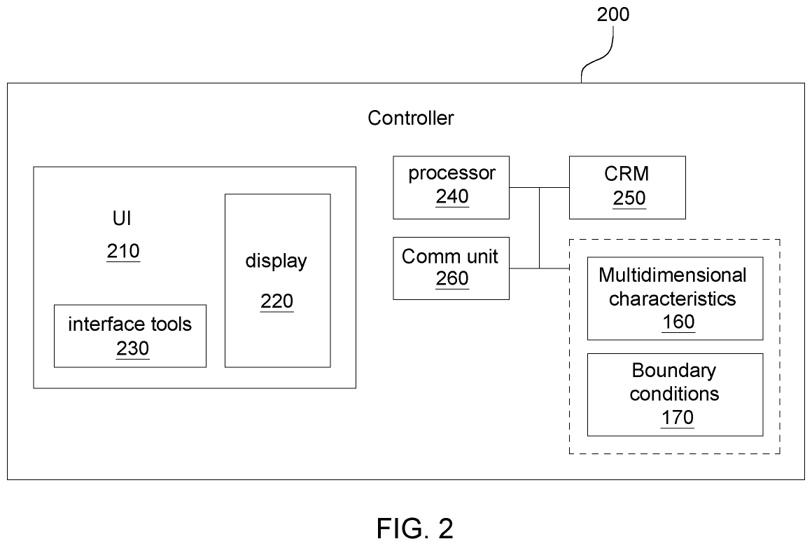

Referring now to FIG. 2, the system 100 may include at least one controller 200. The controller 200 may be configured to receive input signals including or corresponding to captured images or equivalent material characterizing data from the one or more perception sensors 140a, 140b, . . . , 140n. The controller 200 may be configured to detect and/or predict a boundary condition 170 associated with the at least first stockpile 130a. The boundary condition 170 may be detected and/or predicted based at least in part on the monitored one or more multidimensional characteristics 160 thereof.

In one optional embodiments, the one or more perception sensors 140a, 140b, 140n may include video cameras configured to record an original image stream and transmit corresponding data to the controller 200. In the alternative or in addition, the one or more perception sensors 140a, 140b, . . . , 140n may include one or more infrared cameras, a stereoscopic camera, a PMD camera, or the like. One of skill in the art may appreciate that in certain embodiments high resolution light detection and ranging (LIDAR) scanners, radar detectors, laser scanners, and the like may be implemented as part of the one or more perception sensors 140a, 140b, . . . , 140n or otherwise alongside the above-referenced examples within the scope of the present disclosure. The number and orientation of perception sensors 140 or components thereof may vary in accordance with the type of system 100 and relevant applications, but may typically be configured to capture image data associated with at least an entire width of each of the plurality of conveyors 125a, 125b, . . . , 125n.

The position and size of an image region recorded by a respective camera as a perception sensor 140 may for example depend on the arrangement and orientation of the camera and the camera lens system, in particular the focal length of the lens of the camera, but may desirably be configured to capture substantially the entire width of each of the plurality of conveyors 125a, 125b, . . . , 125n during a material comminuting operation. However, a perception sensor 140 configured to capture only a portion of comminuted material being discharged from the work machine 120 may in some embodiments be satisfactory.

Various image data processing functions may be performed discretely at a given perception sensor 140 if properly configured, but also or otherwise may generally include at least some image data processing by the controller 200 or other downstream data processor. For example, image data from any one or more perception sensors 140a, 140b, . . . , 140n may be provided for three-dimensional point cloud generation, image segmentation, object delineation and classification, and the like, using image data processing tools as are known in the art in combination with the objectives disclosed.

In various embodiments, image data processing functions may include a framework for extracting characteristic features from an image based at least in part on learned and implemented attributes associated with previous images and/or input data sets, which may for example have been classified, tagged, labeled, or otherwise associated with comminution states for determining an appropriate action.

One or more controllers 200 may in accordance with various embodiments of the present disclosure be associated with one or more of the material screening machines 120a, 120b, . . . , 120n and/or one or more of the stockpile clearing vehicles 150a, 150b, 150n. A controller 200 of the system 100 may be configured to produce outputs, as further described below, to a user interface 210 associated with a display unit 220 for display to the human operator. A controller 200 may be configured to receive inputs from the user interface 210, such as user input provided via interface tools 230 (e.g., keyboard, touch screen, buttons) associated with the user interface 210. Not specifically represented in FIG. 2, a controller 200 of the system 100 may in some embodiments further receive inputs from and generate outputs to remote devices associated with a user via a mobile computing device or the like. Data transmission between for example the system 100 and a remote user interface may take the form of a wireless communications system and associated components as are conventionally known in the art. The user interface 210, display unit 220, and/or interface tools 230 may be associated with the one or more work machines 120a, 120b, . . . , 120n and/or the one or more stockpile clearing vehicles 150a, 150b, . . . , 150n.

Various operations, steps or algorithms as described in connection with the controller 200 can be embodied directly in hardware, in a computer program product such as a software module executed by a processor 240, or in a combination of the two. The computer program product can reside in RAM memory, flash memory, ROM memory, EPROM memory, EEPROM memory, registers, hard disk, a removable disk, or any other form of computer-readable medium 250 known in the art. An exemplary computer-readable medium 250 can be coupled to the processor 240 such that the processor 240 can read information from, and write information to, the memory/storage medium 250. In the alternative, the medium 250 can be integral to the processor 240. The processor 240 and the medium 250 can reside in an application specific integrated circuit (ASIC). The ASIC can reside in a user terminal. In the alternative, the processor 240 and the medium 250 can reside as discrete components in a user terminal.

The term “processor” 240 as used herein may refer to at least general-purpose or specific-purpose processing devices and/or logic as may be understood by one of skill in the art, including but not limited to a microprocessor, a microcontroller, a state machine, and the like. A processor 240 can also be implemented as a combination of computing devices, e.g., a combination of a DSP and a microprocessor, a plurality of microprocessors, one or more microprocessors in conjunction with a DSP core, or any other such configuration.

A communication unit 260 may support or provide communications between the controller 200 and external communications units, systems, or devices, and/or support or provide communication interface with respect to internal components of the system 100. The communications unit 260 may include wireless communication system components (e.g., via cellular modem, WiFi, Bluetooth or the like) and/or may include one or more wired communications terminals such as universal serial bus ports.

Data storage 270 as further described below may, unless otherwise stated, generally encompass hardware such as volatile or non-volatile storage devices, drives, electronic memory, and optical or other storage media, as well as in certain embodiments one or more databases residing thereon. In an embodiment, the data storage 270 may be configured to receive and retrievably store data sets, models, and/or algorithms, for further performing programmatic operations or the like as further disclosed herein, including but not limited to characteristic features extracted from captured images using image processing, boundary conditions 170 as set manually via user input or as automatically determined or dynamically adjusted over time, etc.

In certain optional embodiments, a respective controller 200 or other processing unit linked thereto for the purpose of image processing may utilize image segmentation where available with respect to identified multidimensional characteristics 160. In one example, a multidimensional characteristic 160 extracted from a captured image may be a size of individual material fragments from the comminuted material in the image region of the one or more perception sensors 140a, 140b, . . . , 140n. The controller 200 may utilize data from the one or more perception sensors 140a, 140b, . . . , 140n and/or from the one or more work machines 120a, 120b, . . . , 120n (such as the rotational speed of the plurality of conveyors 125a, 125b, . . . , 125n) to predict one or more boundary conditions 170 of the one or more stockpiles 130a, 130b, . . . , 130n. The one or more boundary conditions 170 of each of the one or more stockpiles 130a, 130b, . . . , 130n may be associated with a height 132 of the stockpile 130 and/or a volume of the stockpile 130, to name a few examples. The controller 200 may also be configured to detect a growth rate of the one or more stockpiles 130a, 130b, . . . , 130n, in the work area. The growth rate may be a prediction based on other multidimensional characteristics 160 detected by the one or more perception sensors 140a, 140b, . . . , 140n.

In certain optional embodiments, a predetermined threshold may be associated with the one or more boundary conditions 170. For example, a threshold height 132 or a threshold volume may be defined and associated with a respective one of the one or more stockpiles 130a, 130b, . . . , 130n. In some optional embodiments, the threshold boundary condition 170 may correspond to size of the stockpile 130 respective to one of the plurality of conveyors 125a, 125b, . . . 125n of the one or more work machines 120a, 120b, . . . , 120n. Thus, the threshold boundary condition 170 may be a desired stockpile 130 size that can reasonably be loaded from beneath one of the plurality of conveyors 125a, 125b, . . . , 125n. In other optional embodiments, the threshold boundary condition 170 may correspond to a desired size of the stockpile 130 that is unrelated to the plurality of conveyors 125a, 125b, . . . 125n of the one or more material screening machines 120a, 120b, . . . , 120n.

In certain optional embodiments, the controller 200 may monitor trends over time with respect to the identified multidimensional characteristics 160, wherein the controller 200 may further be configured to predict an upcoming violation of the predetermined threshold associated with the boundary conditions 170 based at least in part on the monitored trend and generate output signals accordingly.

Thus, the one or more perception sensors 140a, 140b, . . . , 140n may monitor one or more multidimensional characteristics 160 associated with the one or more stockpiles 130a, 130b, . . . , 130n. The one or more perception sensors 140a, 140b, . . . , 140n may monitor the comminuted material processed by a respective work machine 110, 120. The controller 200 may detect and/or predict a boundary condition 170 associated with the one or more stockpiles 130a, 130b, . . . , 130n based at least in part on the monitored one or more multidimensional characteristics 160 thereof.

Various of the one or more work machines 110, 120 and the one or more stockpile clearing vehicles 150a, 150b, . . . , 150n may be associated with a respective communication unit 260. The communication unit 260 may be associated with controller 200 or may be an independent unit. Thus, work machines 110, 120 and stockpile clearing vehicles 150a, 150b, . . . , 150n may include controller 200 having communication unit 260 or may simply include communication unit 260 independent of controller 200.

In an embodiment, each of the one or more material screening machine s 120a, 120b, . . . , 120n and the one or more stockpile clearing vehicles 150a, 150b, . . . , 150n may be operable to selectively communicate. In certain optional embodiments, the one or more material screening machine s 120a, 120b, . . . , 120n and the one or more stockpile clearing vehicles 150a, 150b, . . . , 150n may be associated with a work area communications network. The work area communications network may be configured to enable communication between at least the one or more material screening machine s 120a, 120b, . . . , 120n and the one or more stockpile clearing vehicles 150a, 150b, 150n. The work area communications network may enable communication via cellular modem, WiFi, Bluetooth or the like. Communication between the one or more material screening machines 120a, 120b, . . . , 120n and the one or more stockpile clearing vehicles 150a, 150b, . . . , 150n may be limited based for example on the proximity of the machines, terrain between the machines, and/or other associated factors.

The controller 200 may be configured to, upon initiating or reestablishing communication between at least a first material screening machine 120a and a first stockpile clearing vehicle 150a associated with the work area, selectively generate output signals corresponding to the one or more multidimensional characteristics 160 and/or the one or more boundary conditions 170 of the stockpile 130. For example, an operator for a respective stockpile clearing vehicle 150 needs an indication as to whether a stockpile needs to be cleared and potentially which stockpile from a plurality of stockpiles needs to be cleared. However, sometimes the stockpile clearing vehicle 150 is too far away (e.g., outside of communication range or if there is too much interference due to topology of the site, i.e. WiFi, radio, etc.) to guarantee reception of such an indication, as it should be noted that many worksites may not have reliable cellular coverage.

Accordingly, in various embodiments communication between the first work machine 120a and the first stockpile clearing vehicle 150a may be initiated or reestablished based in part on proximity of the first material screening machine 120a relative to the first stockpile clearing vehicle 150a. Thus, the communication unit 260 associated with each of the one or more material screening machines 120a, 120b, . . . 120n and the one or more stockpile clearing vehicles 150a, 150b, . . . , 150n may have an effective range of communication. For example, communication between the first material screening machine 120a and the first stockpile clearing vehicle 150a may be initiated or reestablished when either of the first material screening machine 120a and the first stockpile clearing vehicle 150a comes within the effective range of communication of the other.

The output signals generated by the controller 200 may correspond to an alert and/or message when the one or more multidimensional characteristics 160 and/or the one or more boundary conditions 170 of a respective stockpile 130 reaches the predetermined threshold. The alert and/or message may be a request for the stockpile 130 to be cleared, may indicate a certain boundary condition 170 of the stockpile has reached a predetermined threshold, may indicate an amount of time before a boundary condition 170 of the stockpile reaches a predetermined threshold, or relay any other information associated with the stockpile 130.

The one or more stockpile clearing vehicles 150a, 150b, . . . , 150n may receive the alert and/or message. The stockpile clearing vehicle 150 may selectively generate either a positive response signal or a negative response signal. In certain optional embodiments, generation of the positive or negative response signals may be in response to user input by an operator of the stockpile clearing vehicle 150. In other optional embodiments, generation of the positive or negative response signals may be automatically generated via at least the communication unit of the stockpile clearing vehicles 150 if the stockpile clearing vehicle 150 has already been assigned another task at the work area. The positive response signal may indicate that the stockpile clearing vehicle 150 will perform the loading operation. The negative response signal may indicate that the stockpile clearing vehicle 150 will not intend to perform the loading operation.

Upon receiving the negative response signal from the stockpile clearing vehicle 150, the controller 200 may be configured to generate additional output signals corresponding to the boundary condition 170 of the stockpile 130. These additional output signals may be received by other stockpile clearing vehicles 150 who may be able to perform the loading operation. Upon receiving the positive response signal from the stockpile clearing vehicle 150, the controller 200 may be configured to stop the generation of output signals corresponding to the boundary condition 170 of the stockpile 130. One advantage of stopping the generation of output signals may be that only one of the one or more stockpile clearing vehicles 150a, 150b, . . . , 150n moves to the respective stockpile 130.

The stockpile clearing vehicles 150a, 150b, . . . , 150n may perform the loading operation in association with one of the one or more stockpiles 130a, 130b, . . . , 130n. The stockpile clearing vehicle 150 may generate output signals corresponding to the loading operation. For example, the output signals may indicate a volume of comminuted material removed from the stockpile 130. The controller 200 may receive the output signals from the stockpile clearing vehicle 150, and adjust the predicted boundary condition 170 associated with the stockpile 130 in response.

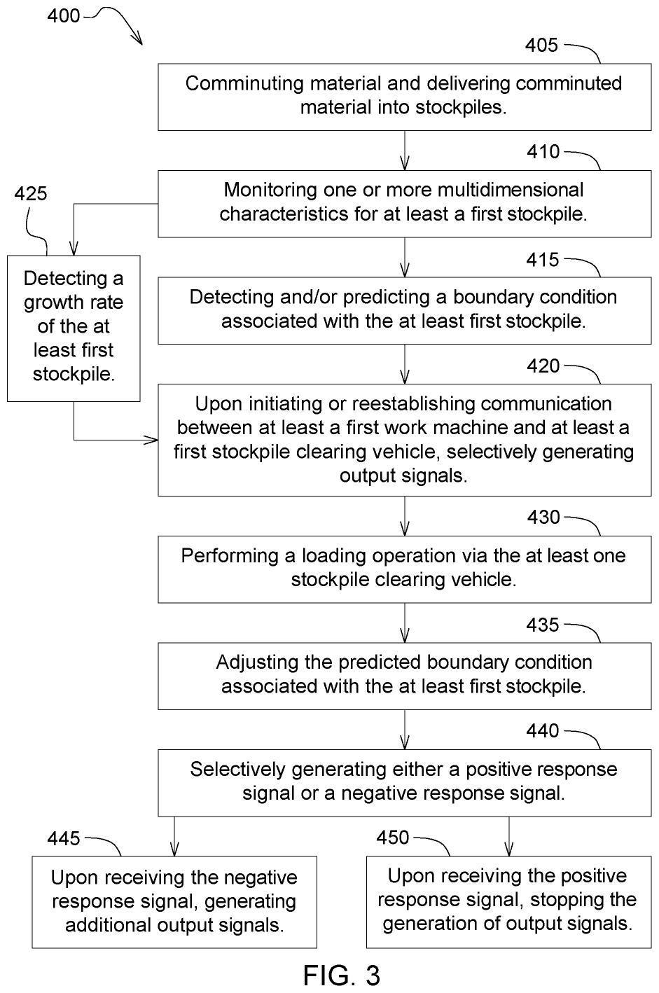

Referring next to FIG. 3, an embodiment of a method 400 may now be described which is exemplary but not limiting on the scope the present disclosure unless otherwise specifically noted. One of skill in the art may appreciate that alternative embodiments may include fewer or additional steps, and that certain disclosed steps may for example be performed in different chronological order or simultaneously.

The method 400 begins by, via one or more work machines 110, 120, comminuting material (step 405) from the work area and delivering the comminuted material into one or more stockpiles 130a, 130b, . . . , 130n.

In step 410, one or more multidimensional characteristics 160 for at least a first stockpile 130a of the one or more stockpiles 130a, 130b, . . . , 130n may be monitored via one or more perception sensors 140a, 140b, . . . , 140n.

In step 415, a boundary condition 170 associated with the at least first stockpile 130a of the one or more stockpiles 130a, 130b, . . . , 130n may be detected and/or predicted based at least in part on the monitored one or more multidimensional characteristics 160 thereof. In certain optional embodiments, the boundary condition 170 may be detected and/or predicted via a controller 200 associated with the at least first work machine 120a of the one or more material screening machines 120a, 120b, 120n. In other optional embodiments, the boundary condition 170 is detected and/or predicted via a controller 200 associated with the at least first stockpile clearing vehicle 150a of the one or more stockpile clearing vehicles 150a, 150b, . . . , 150n. The boundary condition 170 may correspond at least in part to a volume of the at least one stockpile 130a in the work area.

In step 420, upon initiating or reestablishing communication between at least a first material screening machine 120a and at least a first stockpile clearing vehicle 130a associated with the work area, selectively generating output signals corresponding to the one or more multidimensional characteristics 160 and/or boundary condition 170 of the at least first stockpile 130a. Communication may be initiated or reestablished between the at least first material screening machine 120a and the at least first stockpile clearing vehicle 150a in the work area based at least in part on proximity of the at least first material screening machine 120a relative to the at least first stockpile clearing vehicle 150a. Communication between the at least first material screening machine 120a and the at least first stockpile clearing vehicle 150a may be done via the preexisting work area communications network. The output signals may correspond to an alert when the one or more multidimensional characteristics 160 and/or the boundary condition 170 of the at least first stockpile 130a reaches a predetermined threshold.

In step 425, the controller 200 associated with the at least first material screening machine 120a may detect a growth rate of the at least first stockpile 130 of the one or more stockpiles 130a, 130b, . . . , 130n in the work area.

In step 430, the at least one stockpile clearing vehicle 150a may perform a loading operation wherein the comminuted material is removed from the at least first stockpile 130a in the work area.

In step 435, the predicted boundary condition 170 associated with the at least first stockpile 130a may be adjusted in response to the loading operation of step 430.

In step 440, either a positive response or a negative response may be selectively generated via the at least first stockpile clearing vehicle 150a. The positive response signal may indicate the at least first stockpile clearing vehicle 150a will perform a loading operation. The negative response signal may indicate that the at least first stockpile clearing vehicle 150a does not intend to perform the loading operation.

In step 445, upon receiving negative response signal from the at least first stockpile clearing vehicle 150 in the work area, additional output signals may be generated corresponding to the boundary condition 170 of the at least first stockpile 130a in the work area.

In step 450, upon receiving the positive response signal from the at least first stockpile clearing vehicle 150a in the work area, the generation of output signals corresponding to the boundary condition 170 of the at least first stockpile 130a in the work area may be stopped.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A method of coordinating clearance of a work area comprising one or more stockpiles of comminuted material worked via one or more work machines, the method comprising:
automatically monitoring, via one or more perception sensors, and for at least a first stockpile of the one or more stockpiles, one or more multidimensional characteristics thereof;
ascertaining a boundary condition associated with the at least first stockpile, based at least in part on the monitored one or more multidimensional characteristics thereof; and
upon initiating or reestablishing communication between at least a first work machine of the one or more work machines and at least a first stockpile clearing vehicle of one or more stockpile clearing vehicles associated with the work area, selectively generating output signals corresponding to the one or more multidimensional characteristics and/or the boundary condition of the at least first stockpile.

2. The method of claim 1, wherein:
ascertaining the boundary condition comprises detecting and/or predicting the boundary condition via a controller associated with the at least first work machine.

3. The method of claim 1, wherein:
ascertaining the boundary condition comprises detecting and/or predicting the boundary condition via a controller associated with the at least first stockpile clearing vehicle.

4. The method of claim 1, wherein:
communication is initiated or reestablished between the at least first work machine and the at least first stockpile clearing vehicle in the work area based at least in part on proximity of the at least first work machine relative to the at least first stockpile clearing vehicle.

5. The method of claim 1, wherein:
communication between the at least first work machine and the at least first stockpile clearing vehicle is initiated or reestablished via a preexisting work area communications network.

6. The method of claim 1, wherein:
the monitored one or more multidimensional characteristics comprise a growth rate of the at least first stockpile in the work area ascertained via a controller associated with the at least first work machine.

7. The method of claim 1, wherein:
the step of selectively generating output signals includes selectively generating an output signal corresponding to an alert when the one or more multidimensional characteristics and/or the boundary condition of the at least first stockpile reaches a predetermined threshold.

8. The method of claim 1, further comprising:
performing a loading operation via the at least one stockpile clearing vehicle wherein the comminuted material is removed from the at least first stockpile in the work area.

9. The method of claim 8, further comprising:
adjusting the predicted boundary condition associated with the at least first stockpile in the work area in response to the loading operation.

10. The method of claim 1, further comprising:
selectively generating either a positive response signal or a negative response signal via the at least first stockpile clearing vehicle, wherein the positive response signal indicates the at least first stockpile clearing vehicle will perform a loading operation, and the negative response signal indicates the at least first stockpile clearing vehicle will not intend to perform the loading operation.

11. The method of claim 10, further comprising:
upon receiving the negative response signal from the at least first stockpile clearing vehicle in the work area, generating output signals to additional stockpile clearing vehicles corresponding to the boundary condition of the at least first stockpile in the work area.

12. The method of claim 10, further comprising:
upon receiving the positive response signal from the at least first stockpile clearing vehicle in the work area, stopping the generation of output signals corresponding to the boundary condition of the at least first stockpile in the work area.

13. The method of claim 1, wherein:
the boundary condition corresponds at least in part to a volume of the at least one stockpile in the work area.

14. A system of coordinating clearance of a work area, the system comprising:
one or more work machines configured to comminute material from a work area and deliver the comminuted material into one or more stockpiles;
one or more perception sensors configured to monitor, for at least a first stockpile, one or more multidimensional characteristics thereof;
a controller configured to detect and/or predict a boundary condition associated with the at least first stockpile, based at least in part on the monitored one or more multidimensional characteristics thereof; and
wherein the controller is configured to, upon initiating or reestablishing communication between at least a first work machine of the one or more work machines and at least a first stockpile clearing vehicle of one or more stockpile clearing vehicles associated with the work area, selectively generate output signals corresponding to the one or more multidimensional characteristics and/or the boundary condition of the at least one stockpile.

15. The system of claim 14, wherein:
the controller is associated with the at least first work machine.

16. The system of claim 14, wherein:
communication is initiated or reestablished between the at least first work machine and the at least first stockpile clearing vehicle based at least in part on proximity of the at least first work machine relative to the at least first stockpile clearing vehicle.

17. The system of claim 14, further comprising:
a work area communications network configured to enable communication between the at least first work machine and the at least first stockpile clearing vehicle.

18. The system of claim 14, wherein:
the controller is configured to detect a growth rate of the at least first stockpile in the work area.

19. The system of claim 14, wherein:
the controller is configured to generate an output signal corresponding to an alert when the one or more multidimensional characteristics and/or the boundary condition of the at least first stockpile reaches a predetermined threshold.

20. The system of claim 14, wherein:
the one or more stockpile clearing vehicles are configured to perform a loading operation wherein the comminuted material is removed from the at least first stockpile in the work area.
